(19) United States
(12) Patent Application Publication
(10) Pub. No.: US 2007/0016687 A1
(43) Pub. Date: Jan. 18, 2007

(54) System and method for detecting imbalances in dynamic workload scheduling in clustered environments

(75) Inventors: Manoj K. Agarwal, New Delhi (IN); Sugata Ghosal, New Delhi (IN); Manish Gupta, New Delhi (IN); Vijay Mann, Haryana (IN); Lily Mummert, Mahopac, NY (US); Nikolaos Anerousis, Chappaqua, NY (US)

Correspondence Address: Frederick W. Gibb, III;McGinn & Gibb, PLLC, Suite 304, 2568-A Riva Road, Annapolis, MD, 21401, US

(73) Assignee: International Business Machines Corporation, Armonk, NY (US)

(21) Appl. No.: 11/181,352

(22) Filed: Jul. 14, 2005

(51) Int. Cl. G06F 15/173

(52) U.S. Cl. 709/238

(57) ABSTRACT

Methods, systems and computer program products for detecting a workload imbalance in a dynamically scheduled cluster of computer servers are disclosed. One such method comprises the steps of monitoring a plurality of metrics at each of the computer servers, detecting change points in the plurality of metrics, generating alarm points based on the detected change points, correlating the alarm points and identifying, based on an outcome of the correlation, one or more of the computer servers causing a workload imbalance. Systems and computer program products for practicing the above method are also disclosed.

### FIELD OF THE INVENTION

The present invention relates to the detection of workload imbalances in dynamically scheduled cluster-based environments and more particularly to the identification of cluster members responsible for said imbalances.

### BACKGROUND

Workload scheduling in cluster based application processing environments (commonly know as ‘Application Servers’) is commonly performed on a weighted round robin basis. Typically, routing weights are statically assigned to the various backend servers when the cluster is created. In more recent application servers, routing weights are dynamically assigned based on monitored runtime metrics. Dynamic workload scheduling usually takes metrics such as CPU utilization on specific servers and the response times observed from those servers into consideration when assigning routing weights to those servers.

On occasion, due to a fault occurring in an application on a particular server or to an external condition (e.g., severed network connectivity to the database), the affected server may begin to process requests rapidly on account of not performing any real work. This may result in lower response times from that server compared to other servers, which may be interpreted as a sign of ‘speed and efficiency’ by the workload manager. Accordingly, the workload manager may assign a higher routing weight to the affected server, thus delegating even more requests to that server, which will typically result in more and more requests completing incorrectly. This condition is known as Storm Drain and is typically brought about by a fault in one of the servers in a cluster whereas the other servers in that cluster remain healthy.

In a paper entitled “Detecting Application-Level Failures in Component-based Internet Services”, to appear in IEEE transactions on Neural Networks: Special Issue on Adaptive Learning Systems in Communication Networks (invited paper), Spring 2005, the authors Emre Kiciman and Armando Fox present an approach for detecting and localizing anomalies in such services. The “Pinpoint” approach comprises a three-stage process of observing the system, learning the patterns in its behavior, and looking for anomalies in those behaviors. During the “observation” stage, the runtime path of each request served by the system is captured. Specific low-level behaviors are extracted from the runtime paths of the requests, namely, “component interactions” and “path shapes”. Neither of these low-level behaviors can be used to effectively detect the Storm Drain condition as changes in the “component interactions” and “path shapes” can result from a variety of reasons such as an application version change, a request mix change, etc. in addition to the Storm Drain condition. Furthermore, the Storm Drain condition can result from a backend system failure which resides outside the application being considered and is therefore outside the scope of detection by the Pinpoint approach. In such cases, the “component interactions” and “path shapes” do not change on occurrence of a Storm Drain condition and are therefore not a reliable indicator of a Storm Drain condition.

Vasundhara Puttagunta and Konstantinos Kalpakis, in a paper entitled “Adaptive Methods for Activity Monitoring of Streaming Data”, Proceedings of the 2002 International Conference on Machine Learning and Applications (ICMLA'02), Las Vegas, Nevada, Jun. 24-27, 2002, pp. 197-203, discuss methods for detecting a change point in a time series to detect interesting events. Guralnik, V. and Srivistava, J., in “Knowledge Discovery and Data Mining”, 1999, pages 33-42, also discuss time series change point detection techniques. These methods and techniques examine a single time series including historical data, which would frequently and disadvantageously result in false detection of a Storm Drain condition.

Ganti, V., Gehrke, J. and Ramakrishnan, R., in a paper entitled “DEMON: Mining and monitoring evolving data”, ICDE, 2000, pages 439-448, present a generic model maintenance algorithm that processes incremental data. This technique can be used as an alternative to change point detection to detect abnormalities in a given single time series data. However, the algorithm disadvantageously requires maintenance of several models within a time series and cannot detect Storm Drain by itself without the support of additional mechanisms described in this document.

In a paper entitled “Integrated Event Management: Event Correlation using Dependency Graphs”, Proceedings of 9^{th} IFIP/IEEE International Workshop on Distributed Systems: Operations and Management (DSOM 98), October 1998, the author Gruschke, B. discusses correlation of different events emanating from different software or hardware components in a system using a dependency graph. This approach disadvantageously requires substantial support from existing hardware and software infrastructure and may require the creation of new event generation mechanisms as new backend components are added to the system.

U.S. Patent Application No. 20030110007, entitled “System and Method for Monitoring Performance Metrics”, was filed in the name of McGee, J. et al. and was published on Jun. 12, 2003. The document relates to a system and method for correlating different performance metrics to monitor the performance of web-based enterprise systems and is not directed to the detection of workload imbalances. Furthermore, no mechanism is disclosed for distinguishing Storm Drain behavior from normal performance problems.

Existing methods and systems for detecting workload imbalances generally assume that an increase in response time and a reduction in throughput are symptomatic of a potential problem. However, the Storm Drain condition exhibits diametrically opposed symptoms (i.e., reduced response times and increased throughput). Accordingly, a different approach is needed.

A need exists for methods and systems capable of reliably and precisely detecting a Storm Drain condition that occurs due to a backend computer server failure.

### SUMMARY

Aspects of the present invention relate to methods, systems and computer program products for detecting a workload imbalance in a dynamically scheduled cluster of computer servers.

An aspect of the present invention provides a method for detecting a workload imbalance in a dynamically scheduled cluster of computer servers. The method comprises the steps of monitoring a plurality of metrics at each of the computer servers, detecting change points in the plurality of metrics, generating alarm points based on the detected change points, correlating the alarm points and identifying, based on an outcome of the correlation, one or more of the computer servers causing a workload imbalance.

Another aspect of the present invention provides a system for detecting a workload imbalance in a dynamically scheduled cluster of computer servers. The system comprises a plurality of sensors for monitoring a plurality of metrics at each of the computer servers, a change point detector for detecting changes in the plurality of metrics and generating alarm points based on the detected changes, a correlation engine for correlating the alarm points generated from the plurality of metrics and identifying, based on an outcome of the correlation, one or more of the computer servers causing a workload imbalance.

Another aspect of the present invention provides a system for detecting a workload imbalance in a dynamically scheduled cluster of computer servers, which comprises a memory unit for storing data and instructions to be performed by a processing unit and a processing unit coupled to the memory unit. The processing unit is programmed to monitor a plurality of metrics at each of the computer servers, detect change points in the plurality of metrics, generate alarm points based on the detected change points, correlate the alarm points and identify, based on an outcome of the correlation, one or more of the computer servers causing a workload imbalance.

Yet another aspect of the present invention provides a computer program product comprising a computer readable medium comprising a computer program recorded therein for detecting a workload imbalance in a dynamically scheduled cluster of computer servers. The computer program product comprises computer program code for monitoring a plurality of metrics at each of the computer servers, computer program code for detecting change points in the plurality of metrics, computer program code for generating alarm points based on the detected change points, computer program code for correlating the alarm points and computer program code for identifying, based on an outcome of the correlation, one or more of the computer servers causing a workload imbalance.

### BRIEF DESCRIPTION OF THE DRAWINGS

A small number of embodiments are described hereinafter, by way of example only, with reference to the accompanying drawings in which:

FIG. 1 is a schematic block diagram of a clustered application processing environment;

FIG. 2 is a schematic block diagram of a Storm Drain Detection System operating on a clustered application processing environment;

FIGS. 3a and 3b are graphical representations of time series data for describing a method for detecting change points in the time series data;

FIG. 4 is a flow diagram of a method for detecting a workload imbalance in a dynamically scheduled cluster of computer servers; and

FIG. 5 is a schematic block diagram of a computer system with which embodiments of the present invention may be practised.

### DETAILED DESCRIPTION

Embodiments of a method, a system and a computer program product are described hereinafter for detecting excessive or anomalous amounts of work delegated to one or more backend servers in a cluster-based application processing environment and/or detecting when the requests made on the backend servers are incorrectly executed.

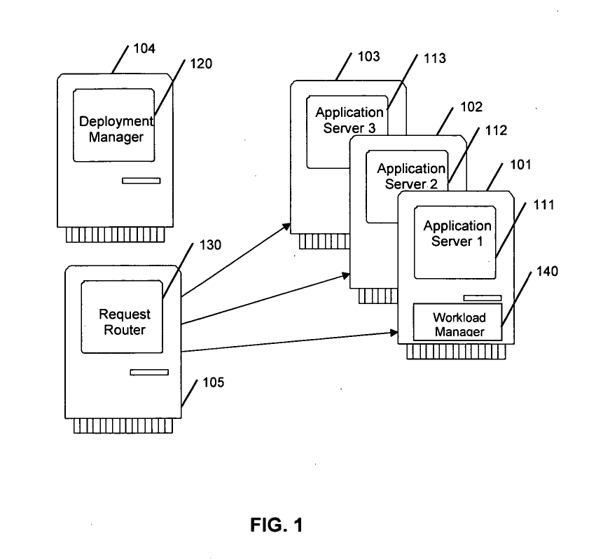

FIG. 1 is a schematic block diagram of a clustered application processing environment, which consists of multiple nodes (typically, a physical machine comprises a single node), one or more backend computer systems 101 to 105 on each respective node, a deployment manager 120 that executes on computer system 104 to provide a single point of administration for the entire cluster, a workload manager 140 that executes on computer system 101 to assign dynamic routing weights to the different nodes in the cluster and a request router 130 that executes on computer system 105 and serves as a proxy to route requests to the application servers 101, 102 and 103 in the system in accordance with the dynamic routing weights assigned by the workload manager 140. In FIG. 1, the workload manager 140 is collocated with application server 101, and the deployment manager 120 and request router 130 are hosted by computer systems 104 and 105, respectively, which do not also act as application servers. However, as one skilled in the art would appreciate, alternative configurations and/or location of system components are possible.

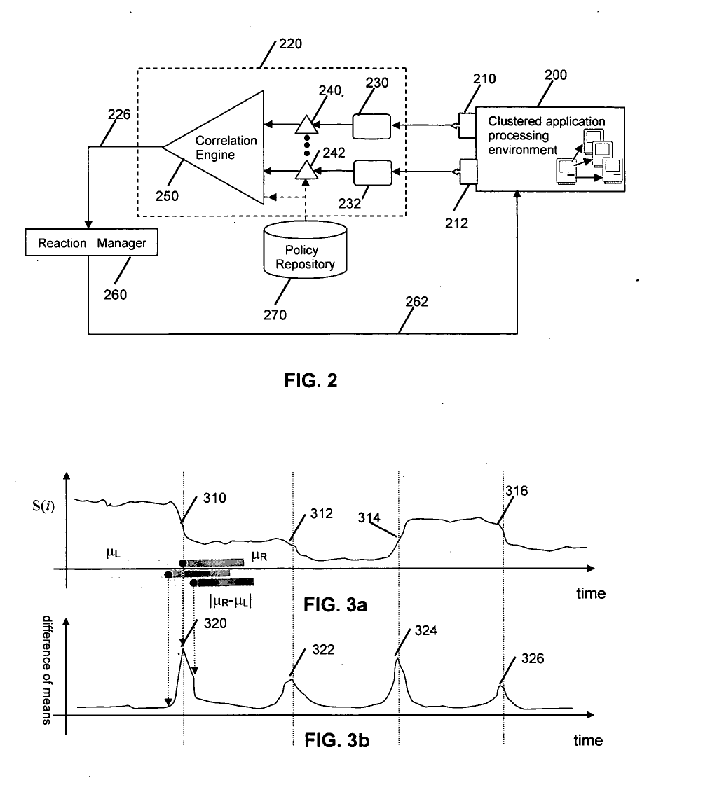

FIG. 2 is a schematic block diagram of a Storm Drain Detection System operating on a clustered application processing environment 200 such as that shown in FIG. 1. The Storm Drain Health Sensors 210, 212 monitor and sample system metrics and metrics related to the stream of requests at each of the backend computer servers of the cluster 200. A Storm Drain Health Subsystem 220 applies heuristics and/or algorithms to the monitored data to determine epochs when changes in the monitored metrics occur and call these epochs as potential alarm points. A Reaction Manager 260 facilitates automated or supervised reactions to Storm Drain conditions, including but not limited to: (a) stopping routing/scheduling of requests to the affected computer server(s), (b) quiescing the affected computer server(s), and (c) rejuvenating the affected computer server(s). The components of the Storm Drain Detection System are further described hereinafter.

Storm Drain Health Sensors

The Storm Drain Health Sensors 210, 212 typically comprise monitoring & sampling components of two kinds:
A response time sensor for each server in the cluster that samples the observed average response time for a given time period. In order to improve accuracy, a different response time sensor can be created for each application on a server that collects response time samples at the granularity of an application. Depending on the instrumentation available inside the server, response time sensors at further finer granularity (e.g., servlets, URLs, EBJs, etc.) can also be used for greater accuracy.
A cluster weight sensor per node that receives the routing weight for that node from the cluster service which keeps a track of the dynamic weights being assigned to the different nodes. The weight is normalized as a percentage.
   The response time and weight samples are collected at periodic intervals (15 seconds in the current implementation).

Storm Drain Health Sensors are not limited to the two types described above and other sensors that sample metrics such as CPU utilization, memory utilization, etc., can be added to the system to increase the overall detection accuracy.

Storm Drain Health Subsystem

The Storm Drain Health Subsystem 220 comprises Change Point Detectors 230, 232, Alarm Filters 240, 242 and a Correlation Engine 250. The Change Point Detectors 230, 232 receive periodic samples (time series data) from the various health sensors 210, 212 (i.e., the response time and cluster weight sensors) and apply an algorithm/heuristic to determine epochs at which there is a potential ‘change point’ in the process that generated the samples in the time-series. Algorithms used for this purpose in embodiments of the present invention are described hereinafter.

The potential change points detected by the Change Point Detectors 230, 232 are subsequently filtered by the Alarm Filters 240, 242 to exclude those that are likely to be false alarms. More particularly, the Alarm Filters 240, 242 reduce false positives by comparing by how much a given metric (response time or weights) has changed from its past mean value. A potential alarm is discarded as a false alarm if the change is not sufficiently significant. The Alarm Filters 240, 242 make use of policies stored in a Policy Repository 270, which define conditions that have to hold true for a potential change point to be a valid change point and not a false alarm. Examples of such conditions are:
(Change in value)>X percent of the current mean of the value, and
(Change in value)>confidence coefficient*standard deviation of the values.

The confidence coefficient can take different values, for example, 1.96 for 95% confidence (assuming a normal distribution).

In a particular embodiment, the following values were selected:
X=30% for the response time series,
X=20% for the weights series, and
confidence coefficient=1.1 for both the response time series and weights series.

A Correlation Engine 250 is employed by the Storm Drain Health Subsystem 220 to correlate the various alarm points from the different streams generated by sampling of the different metrics and additionally probing the backend computer servers to detect whether they are functioning correctly or not. Change points validated by the Alarm Filters 240, 242 are fed to the Correlation Engine 250 for correlating alarm points generated from the different metrics. Alarm points generated from the response time and weights metrics are correlated and a Storm Drain alarm 226 is generated by the Correlation Engine 250 only if both the alarm points occur in a given time window (e.g., 2 minutes). A Storm Drain alarm 226 is generated under particular circumstances and notified to a Reaction Manager 260.

If application level response time health sensors are used then additional logic can be used to make sure that a Storm Drain alarm 226 is generated only if both the server level response time sensor and the weights sensor generate an alarm point in a time window and the application level response time sensor generates an alarm point for at least one application in the same time window.

Further adjustments can be made to the correlation logic to reduce false positives. For example, CPU utilization on a node can be monitored by a CPU sensor and an alarm can be raised if the CPU utilization on the node shows a sudden significant decrease (perhaps due to completion of an external CPU intensive task on a server) that will result in reduced response times and increased weights for that server. The Correlation Engine 250 may implement logic to generate a Storm Drain alarm 226 only if all the other conditions hold true and an alarm point is not raised by the CPU sensor in the given time window. Similarly, response time sensors that sample response times at relatively finer granularities (such as servlets, EJBs, URLs) can be used in addition to the response time sensor for determining the average response time for the entire server. In such cases, the Correlation Engine 250 can implement logic to generate a Storm Drain alarm 226 only if the average response time for the server raises an alarm point and at least one of the response time sensors operating at a finer granularity also raises an alarm point (in addition to the routing weights alarm point). This ensures that the average response time for the server has not changed due to change in the mix of the requests being served by the servers (e.g., the request mix changes from a mix where the majority of requests are for a set of servlets whose response times are very low to one where the majority of requests are for a set of servlets that take much longer time to respond). This assists in reducing false positives.

Reaction Manager

The Reaction Manager 260 notifies an authority such as the system administrator of a Storm Drain alarm 226 generated by the Correlation Engine 250. For the case of a supervised reaction, the Reaction Manager 260 further provides options to the system administrator for quiescing or stopping the affected server. For the case of an automated reaction, the Reaction Manager 260 automatically quiesces the affected server.

Methods/Algorithms for Determining Potential ‘Change Points’

Method 1: Difference of Means

Input: a series of numbers

Output: the first point where the process that generated the number changes

Let S(i):=ith number, where i=. . . , −2, −1, 0, 1, 2, . . .

Assuming that a change in the generation of S occurs at time 0, it is required to detect that the change point in the above series is indeed 0.

It is required to identify an operator f(i) such that the maxima in the output O(i) (defined below) of the convolution of f(i) with S(i) would comprise the points when a change occurred. Policies or heuristics discussed hereinafter may be used to determine whether the change is “significant” or “is in the right direction”.

$$O ( j ) := \vert {\sum }_{i = - ∞}^{∞} f ( j - i ) S ( i ) \vert \qquad ( 1 )$$

where:
f(i):=1/N if −N≦i<0
−1/N if 0≦i<N
and N is a tuning parameter.

The output O(j) of equation 1 represents the difference of two means. The first mean (called the right mean) is that of the N numbers to the right of j (including the jth number) and the second mean (called the left mean) is that of the N numbers to the left of j. If j is actually a change point then it can be shown that O(j) assumes a local maximum at j. Thus, if O(j) has a local maximum at j then j is declared a change point.

The working of the foregoing difference of means method is shown in FIGS. 3a and 3b. FIG. 3a shows a graphical representation of a series of numbers S(i) as a function of time (i.e., time series data). FIG. 3b, which corresponds in time to FIG. 3a, shows a graphical representation of the differences between the mean of points to the left of the point 310, 312, 314 and 316 where the mean changes and the mean of points to the right of the point 310, 312, 314 and 316 where the mean changes, as a function of time. A key observation from FIG. 3b is that the absolute differences 320, 322, 324 and 326 between the mean of the points to the left and the mean of the points to the right, at the point where the mean changes, is greater than at any other point in the vicinity of the change points 310, 312, 314 and 316. Thus, a point is declared to be a change point if the above observation is satisfied. This method requires a window size (denoted as N) that corresponds to the maximum number of observations needed to empirically determine the means. At any point in time, μ_{R} (the mean of the N samples to the right of the point) and μ_{L} (the mean of the N samples to the left of the point) may be determined. If the absolute difference |μ_{R}−μ_{L}| for the point is greater than the corresponding absolute differences in the ‘vicinity’ of the point, then the point is declared as a ‘change point’. One way to define ‘vicinity’ is to take, say, N points to the immediate left and right of the point under consideration and then perform the above absolute difference analysis.

This method or algorithm can be employed to identify change points in a specific direction (i.e. increasing or decreasing). For Storm Drain detection, the Storm Drain Subsystem 220 employs difference of means separately on the response times and weights samples. For response times, change points are detected in a decreasing direction and for weights, change points are detected in an increasing direction.

Method 2: Covariance Method

This method relies on the fact that response times will start decreasing and routing weights will soon exhibit an increase as a result of a Storm Drain condition. Therefore, if the covariance of two random variables (response time and routing weights) are determined for each server, then the server which exhibits the highest degree of divergence for these two time series (i.e., increasing weights and decreasing response times in the case of a Storm Drain condition, or decreasing weights and increasing response times in a normal overload condition) and which also exhibits the maximum increase in weights (which is not observed in a normal overload condition) in the same time period should be the server experiencing Storm Drain.

For a given time period in which M samples arrive, the following two statistics are computed for each server:
Σ(pi−μ)
Σ[(pi−μ)*(ri−r)]
where: μ=running average of the routing weight of the server,
pi=current weight sample for that server,
r=running average of the response time observed for a server,
ri=current response time sample for that server, and
M=number of samples used to compute the above summations,

The server with max Σ(pi−μ)) will be the server whose weight has increased at the maximum rate in the last time interval. This can result from Storm Drain or from a genuine improvement in the health of a server (e.g., completion of a CPU intensive task on that server).

The statistic min (Σ[(pi−μ)*(ri−r)]) should always be positive for normally operating servers, but will be negative and minimum for a server experiencing Storm Drain or a server which is overloaded. The confidence level in this statistic is directly proportional to the value of M.

Under normal circumstances, when the weight of a server increases, the server starts getting more requests. Accordingly, the server's response time should be higher then the previous cycle as more load is being allocated to the server (the product of 2 positive numbers is a positive number). Conversely, if the weight of a server is decreased, the response time of the server should decrease as less load is being allocated to the server (the product of two negative numbers is a positive number). When a Storm Drain condition occurs, even when the weight of a server is increasing continuously, the server's response time reduces or remains stable around a low value (the product of a positive number and a negative number is a negative number). Such a negative number can also result from a failing server (e.g., an overloaded server) that exhibits higher and higher response times in each cycle despite being assigned lower and lower weights in each cycle.

Since a server cannot be overloaded and also experience an improvement in health at the same time, the only reason for both max(Σ(pi−μ)) and min(Σ[(pi−μ)*(ri−r)]) occurring in a given time interval, is Storm Drain. So for a given time interval in which M samples arrive, if both the statistics max(Σ(pi−μ)) and min(Σ[(pi−pl)*(ri−rl)]) point to the same server, then it can be concluded that a Storm Drain condition is being experienced by that server.

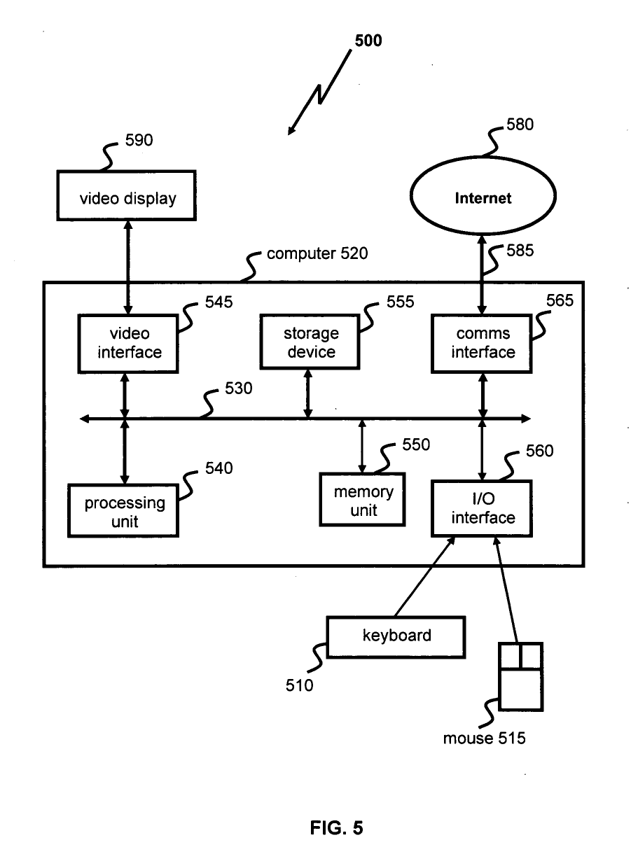

Each of the components described with reference to FIG. 2 may be practiced as computer software, which may be executed on a computer system such as the computer system 500 described hereinafter with reference to FIG. 5.

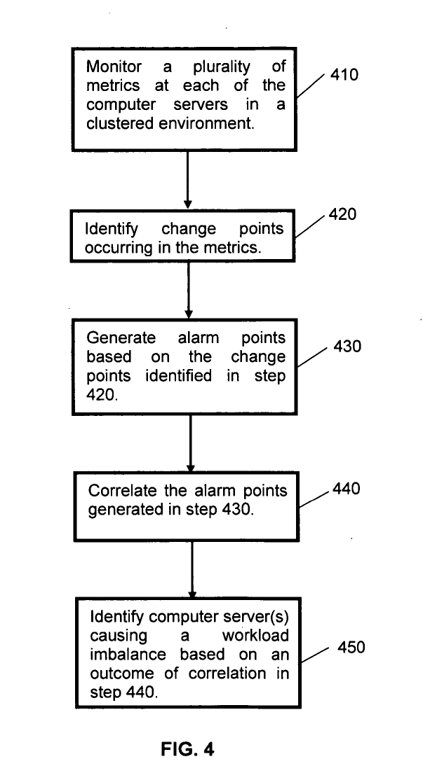

FIG. 4 shows a flow diagram of a method for detecting a workload imbalance in a dynamically scheduled cluster of computer servers.

A plurality of metrics at each of the computer servers in the clustered environment are monitored at step 410. The metrics preferably comprise end-to-end system metrics such as metrics relating to computer server response time and throughput. At step 420, change points in the plurality of metrics are detected. At step 430, alarm points are generated based on the changes detected in step 420. The alarm points generated in step 430 are correlated at step 440. One or more of the computer servers causing a workload imbalance are identified based on an outcome of the correlation performed in step 440, at step 445.

Cumulative response times of requests at each of the computer servers and routing weights dynamically assigned to each of the computer servers may be periodically sampled and time series data representative of response times for the computer servers to respond to requests and routing weights that are dynamically assigned to the computer servers may be generated. Change points in the response time series data that is decreasing and in the routing weights time series data that is increasing may be detected for generation of alarm points. The alarm points may be filtered and/or correlated in a defined time window before being used to identify one or more of the computer servers that are responsible for a workload imbalance. The Reaction Manager may take automated corrective actions including, but not limited to, stopping routing/scheduling of requests to the identified computer server(s), quiescing the identified computer server(s) and/or rejuvenating the identified computer server(s).

FIG. 5 shows a schematic block diagram of a computer system 500 that can be used to practice the methods and systems described herein. More specifically, the computer system 500 is provided for executing computer software that is programmed to assist in performing a method for detecting a workload imbalance in a dynamically scheduled cluster of computer servers. The computer software typically executes under an operating system such as MS Windows 2000, MS Windows XP™ or Linux™ installed on the computer system 500.

The computer software involves a set of programmed logic instructions that may be executed by the computer system 500 for instructing the computer system 500 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code, that perform particular steps of the methods described hereinbefore.

The components of the computer system 400 comprise: a computer 520, input devices 510, 515 and a video display 590. The computer 520 comprises: a processing unit 540, a memory unit 550, an input/output (I/O) interface 560, a communications interface 565, a video interface 545, and a storage device 555. The computer 520 may comprise more than one of any of the foregoing units, interfaces, and devices.

The processing unit 540 may comprise one or more processors that execute the operating system and the computer software executing under the operating system. The memory unit 550 may comprise random access memory (RAM), read-only memory (RQM), flash memory and/or any other type of memory known in the art for use under direction of the processing unit 540.

The video interface 545 is connected to the video display 590 and provides video signals for display on the video display 590. User input to operate the computer 520 is provided via the input devices 510 and 515, comprising a keyboard and a mouse, respectively. The storage device 555 may comprise a disk drive or any other suitable non-volatile storage medium.

Each of the components of the computer 520 is connected to a bus 530 that comprises data, address, and control buses, to allow the components to communicate with each other via the bus 530.

The computer system 400 may be connected to one or more other similar computers via the communications interface 465 using a communication channel 485 to a network 480, represented as the Internet.

The computer software program may be provided as a computer program product, and recorded on a portable storage medium. In this case, the computer software program is accessible by the computer system 500 from the storage device 555. Alternatively, the computer software may be accessible directly from the network 580 by the computer 520. In either case, a user can interact with the computer system 500 using the keyboard 510 and mouse 515 to operate the programmed computer software executing on the computer 520.

The computer system 500 has been described for illustrative purposes. Accordingly, the foregoing description relates to an example of a particular type of computer system such as a personal computer (PC), which is suitable for practising the methods and computer program products described hereinbefore. Those skilled in the computer programming arts would readily appreciate that alternative configurations or types of computer systems may be used to practise the methods and computer program products described hereinbefore.

Embodiments of a method, a system, and a computer program product have been described herein for detecting a workload imbalance in a dynamically scheduled cluster of computer servers. By relying on a combination of high level end-to-end metrics such as response times and routing weights (by way of a correlation process), embodiments of the present invention are able to reliably and precisely detect Storm Drain conditions that occur due to backend computer server failures. Advantageously, such high level end-to-end metrics are typically available as part of the system monitoring infrastructure and do not require modification as new backend components are added to the system or environment.

Embodiments described herein advantageously utilize online data or incremental data samples. Accordingly, only current data in a moving window is required.

The foregoing detailed description provides exemplary embodiments only, and is not intended to limit the scope, applicability or configurations of the invention. Rather, the description of the exemplary embodiments provides those skilled in the art with enabling descriptions for implementing an embodiment of the invention. Various changes may be made in the function and arrangement of elements without departing from the spirit and scope of the invention as set forth in the claims hereinafter.

Where specific features, elements and steps referred to herein have known equivalents in the art to which the invention relates, such known equivalents are deemed to be incorporated herein as if individually set forth. Furthermore, features, elements and steps referred to in respect of particular embodiments may optionally form part of any of the other embodiments unless stated to the contrary.

1. A method for detecting a workload imbalance in a dynamically scheduled cluster of computer servers, said method comprising:
monitoring a plurality of metrics at each of said computer servers;
detecting change points in said plurality of metrics;
generating alarm points based on detected change points;
correlating said alarm points; and
identifying, based on an outcome of said correlating, one or more of said computer servers causing said workload imbalance.

2. The method of claim 1, wherein said metrics comprise end-to-end system metrics.

3. The method of claim 1, wherein said step of monitoring a plurality of metrics at each of said computer servers comprises:
sampling, at periodic intervals, cumulative response times of requests at each of said computer servers; and
sampling, at periodic intervals, routing weights dynamically assigned to each of said computer servers.

4. The method of claim 1, further comprising:
generating time series data representative of response times for said computer servers to respond to requests; and
generating time series data representative of routing weights that are dynamically assigned to said computer servers.

5. The method of claim 4, further comprising:
detecting a change point in said time series data representative of response times that is decreasing; and
detecting a change point in said times series data representative of routing weights that is increasing.

6. The method of claim 5, further comprising: filtering said alarm points.

7. The method of claim 6, wherein said alarm points are correlated in a defined time window.

8. The method of claim 1, further comprising: probing said computer servers to determine whether said computer servers are functioning correctly.

9. The method of claim 1, further comprising notifying a system administrator of occurrence of a Storm Drain condition.

10. The method of claim 9, further comprising at least one of:
stopping routing/scheduling of requests to at least one identified computer server;
quiescing at least one identified computer server; and
rejuvenating at least one identified computer server.

11. A system for detecting a workload imbalance in a dynamically scheduled cluster of computer servers, said system comprising:
a plurality of sensors adapted to monitor a plurality of metrics at each of said computer servers;
a change point detector adapted to detect changes in said plurality of metrics and generate alarm points based on detected changes;
a correlation engine adapted to correlate said alarm points generated from said plurality of metrics and identify, based on an outcome of correlation of said alarm points, one or more of said computer servers causing said workload imbalance.

12. The system of claim 11, wherein said plurality of sensors are adapted to:
sample, at periodic intervals, cumulative response times of requests at each of said computer servers; and
sample, at periodic intervals, routing weights dynamically assigned to each of said computer servers.

13. The system of claim 11, wherein said plurality of sensors are adapted to:
generate time series data representative of response time for said computer servers to respond to requests; and
generate time series data representative of routing weights that are dynamically assigned to said computer servers.

14. The system of claim 13, wherein said change point detector is adapted to:
identify a change point in said time series data representative of response times that is decreasing; and
identify a change point in said times series data representative of routing weights that is increasing.

15. The system of claim 11, further comprising filters adapted to filter said alarm points.

16. The system of claim 15, further comprising a policy repository adapted to store filtering rules for validating said alarm points using said filters.

17. The system of claim 11, further comprising a Reaction Manager adapted to notify an authority of a detected Storm Drain condition.

18. The system of claim 17, wherein said Reaction Manager is adapted to perform at least one of:
stop routing/scheduling of requests to at least one identified computer server;
quiesce at least one identified computer server; and
rejuvenate at least one identified computer server server(s).

19. A system for detecting a workload imbalance in a dynamically scheduled cluster of computer servers, said system comprising:
a memory unit adapted to store data and instructions to be performed by a processing unit; and
a processing unit coupled to said memory unit, said processing unit being programmed to:
monitor a plurality of metrics at each of said computer servers;
detect change points in said plurality of metrics;
generate alarm points based on said detected change points;
correlate said alarm points; and
identify, based on an outcome of said correlation, one or more of said computer servers causing a workload imbalance.

20-22. (canceled)

23. A computer program product comprising a computer readable medium tangibly embodying a computer program recorded therein for performing a method of detecting a workload imbalance in a dynamically scheduled cluster of computer servers, said method comprising:
monitoring a plurality of metrics at each of said computer servers;
detecting change points in said plurality of metrics;
generating alarm points based on detected change points;
correlating said alarm points; and
identifying, based on an outcome of said correlating, one or more of said computer servers causing said workload imbalance.

24-26. (canceled)
